(19) United States
(12) Patent Application Publication
(10) Pub. No.: US 2026/0194992 A1
(43) Pub. Date: Jul. 9, 2026

(54) MOUSE SET

(71) Applicant: WAYMEET (SHENZHEN) TECHNOLOGY CO., LTD., Shenzhen (CN)

(72) Inventor: Qi LIN, Shenzhen (CN)

(73) Assignee: WAYMEET (SHENZHEN) TECHNOLOGY CO., LTD., Shenzhen (CN)

(21) Appl. No.: 19/431,998

(22) Filed: Dec. 23, 2025

(30) Foreign Application Priority Data
Jan. 6, 2025 (CN) 202520027610.4
May 8, 2025 (CN) 202520903001.0
May 26, 2025 (CN) 202521044757.0

(51) Int. Cl. G06F 3/0354

(52) U.S. Cl. CPC G06F 3/03543

(57) ABSTRACT

A mouse set includes: a mouse body, configured to input computer instructions; a mouse base, provided at a target surface and provided at a bottom of the mouse body; and a limiting portion. The mouse body is detachably connected to the mouse base through the limiting portion, and the limiting portion is configured to limit movements of the mouse body and avoid the mouse body separating from the mouse base.

### CROSS-REFERENCE TO RELATED APPLICATIONS

This application claims priority to Chinese Patent Application No. 202520027610.4, filed on January 6, 2025; Chinese Patent Application No. 202520903001.0, filed on May 8, 2025; and Chinese Patent Application No. 202521044757.0, filed on May 26, 2025. All of the aforementioned applications are incorporated herein by reference in their entireties.

### TECHNICAL FIELD

The present application relates to the technical field of input devices, and in particular to a mouse set.

### BACKGROUND

The mouse is used to connect to a computer for controlling the cursor. As an indispensable computer accessory, the mouse makes computer-based office work more flexible. During use, situations may arise where users accidentally move the mouse out of the work area, place the mouse on an inclined surface, or the mouse is impacted. In these situations, the mouse may become unbalanced and tip over or slide, or even fall off the desktop, requiring the user to pick the mouse up or flip the mouse to continue working, causing inconvenience and reducing work efficiency. Furthermore, when the mouse is dropped and subjected to impact, its internal mechanical components are easily damaged, thereby shortening the mouse lifespan and increasing replacement costs.

### SUMMARY

Embodiments of the present application provide a mouse set, which can reduce the probability of the mouse tipping over or sliding and falling, thereby improving the safety of the mouse while enhancing user comfort and work efficiency.

The mouse set in the present application adopts following technical solutions.

The mouse set includes: a mouse body, configured to input computer instructions; a mouse base, provided at a target surface and provided at a bottom of the mouse body; anda limiting portion. The mouse body is detachably connected to the mouse base through the limiting portion, and the limiting portion is configured to limit movements of the mouse body and avoid the mouse body separating from the mouse base.

In an embodiment, the limiting portion includes a first limiting assembly; the first limiting assembly includes a first connecting member, and one of the mouse base and the mouse body is provided with the first connecting member; the mouse body is detachably connected to the mouse base through the first connecting member, and the first connecting member is configured to limit the movements of the mouse body and avoid the mouse body separating from the mouse base.

In an embodiment, the first connecting member is provided at the mouse base, and the mouse body is provided with a first limiting groove corresponding to the first connecting member; the first connecting member is magnetically connected to the mouse body, and an end of the first connecting member away from the mouse base is provided inside the first limiting groove; or

the first connecting member is provided at the mouse body, and the mouse base is provided with a first limiting groove corresponding to the first connecting member; the first connecting member is magnetically connected to the mouse base, and an end of the first connecting member away from the mouse body is provided inside the first limiting groove.

In an embodiment, the first connecting member is provided at the mouse base, and the mouse base is provided with a first receiving groove; the first connecting member is provided inside the first receiving groove and is rotatably matched with the mouse base; or

the first connecting member is provided at the mouse body, and the mouse body is provided with a first receiving groove; the first connecting member is provided inside the first receiving groove and is rotatably matched with the mouse base.

In an embodiment, the first connecting member is provided at the mouse base, and the mouse base is provided with a first receiving groove; a flange is provided at an opening of the first receiving groove; the first limiting assembly further includes a limiting post, and the first connecting member is provided at one end of the limiting post; the limiting post is in sliding fit with the mouse base along a vertical direction, and a limiting ring is provided at an outer peripheral wall of the limiting post; in response to that the first connecting member is magnetically connected to the mouse body, the limiting post is in sliding fit with an inner wall of the first receiving groove, and the limiting ring is abutted against the flange; or

the first connecting member is provided at the mouse body, and the mouse body is provided with a first receiving groove; a flange is provided at an opening of the first receiving groove; the first limiting assembly further includes a limiting post, and the first connecting member is provided at one end of the limiting post; the limiting post is in sliding fit with the mouse base along a vertical direction, and a limiting ring is provided at an outer peripheral wall of the limiting post; in response to that the first connecting member is magnetically connected to the mouse body, the limiting post is in sliding fit with an an inner wall of the first receiving groove, and the limiting ring is abutted against the flange.

In an embodiment, a resetting member is provided between the limiting post and a bottom of the first receiving groove; one end of the resetting member is connected to the bottom of the first receiving groove, and the other end of the resetting member is connected to the limiting post; in response to that a magnetic connection between the first connecting member and the mouse body is released, the resetting member is configured to drive the limiting post to reset.

In an embodiment, the first limiting assembly further includes a second connecting member; the second connecting member is provided in the first limiting groove and corresponds to the first connecting member, and the second connecting member is magnetically connected to the first connecting member;the first connecting member is a magnet, and the second connecting member is an iron piece; or the first connecting member is an iron piece, and the second connecting member is a magnet; or the first connecting member is a magnet, and the second connecting member is a magnet.

In an embodiment, the limiting portion further includes a second limiting assembly; the second limiting assembly is fixedly provided at the mouse base or the mouse body, to limit the mouse body and avoid the mouse body separating from the mouse base along a vertical direction;the second limiting assembly includes a first limiting member and a second limiting member; the first limiting member is provided at one end of the mouse base, and the second limiting member is provided at the other end of the mouse base;the mouse body is provided with a third connecting member and a fourth connecting member; the third connecting member is disposed corresponding to the first limiting member, and the first limiting member is magnetically connected to the third connecting member; the fourth connecting member is disposed corresponding to the second limiting member, and the second limiting member is magnetically connected to the fourth connecting member; andthe first limiting member, the second limiting member, the third connecting member, and the fourth connecting member are magnets.

In an embodiment, the limiting portion includes a first attachment member and a second attachment member;the first attachment member is provided inside the mouse body or at the bottom of the mouse body, and a positioning groove is provided at the bottom of the mouse body;the second attachment member is provided at the mouse base, and a positioning post is movably provided at the mouse base; an end of the positioning post is capable of extending out of a top of the mouse base or retracting inside the mouse base; andin response to that the end of the positioning post extends out of the top of the mouse base, the positioning groove is connected to the end of the positioning post; the first attachment member is attracted to the second attachment member, and the mouse body is connected to the mouse base.

In an embodiment, the positioning post is rotatably disposed at the mouse base, and the positioning post is configured to rotate relative to the mouse base, to extend out of the top of the mouse base or retract inside the mouse base; or

the positioning post is pressed to pop out of the top of the mouse base or retract inside the mouse base.

In an embodiment, the positioning post is popped out from the top of the mouse base or retracted inside the mouse base by means of a push-push pressing structure;

a mounting hole is provided inside the mouse base; the push-push pressing structure is provided inside the mounting hole; the push-push pressing structure includes an indexing cylinder, a rotating cylinder, and an elastic member;

an inner sidewall of the indexing cylinder is provided with a plurality of staggered deep grooves and shallow grooves; the rotating cylinder is provided inside the indexing cylinder, and an outer periphery of the rotating cylinder is provided with a plurality of engaging teeth; one end of the elastic element is connected to an inner of the rotating cylinder, and the other end of the elastic element is connected to an inner wall of the mouse base; the positioning post is connected to the rotating cylinder; and

in response to that the engaging teeth are connected to an inner of each of the deep grooves, the positioning post is configured to retract inside the mouse base; in response to that the engaging teeth are connected to an inner of each of the shallow grooves, the positioning post is popped out from the top of the mouse base.

In an embodiment, the indexing cylinder is integrated with the mouse base into one whole structure; the deep grooves and the shallow grooves are formed at an inner sidewall of the mounting hole.

In an embodiment, the mounting hole is a blind hole, and the elastic element is configured to abut against a bottom of the mounting hole; or

the mounting hole is a through hole; a blocking member is connected to a bottom of the mounting hole, and the elastic element is abutted against the blocking member.

In an embodiment, the mouse base is provided with a plurality of positioning posts, and the bottom of the mouse body is provided with a plurality of positioning grooves;

the plurality of positioning posts are symmetrically distributed about a straight line, and the second attachment member is symmetrical about the straight line; and

the first attachment member is disposed corresponding to the second attachment member.

In an embodiment, the first attachment member includes a magnetic member, and the second attachment member includes a magnetic member and a non-magnetic component to be magnetically attracted; or

the first attachment member includes a magnetic member and a non-magnetic component to be magnetically attracted, and the second attachment member includes a magnetic member.

In an embodiment, a bottom of the mouse base is provided with an adhesive layer, or

a bottom of the mouse base is provided with a magnetic attachment member, or

a bottom of the mouse base is detachably connected to the target surface through a quick-release structure.

In an embodiment, the limiting portion includes a third limiting member; one of the mouse base and the mouse body is provided with the third limiting member and a second receiving groove, and the other of the mouse base and the mouse body is provided with a second limiting groove; the third limiting member is rotatably disposed at the mouse base or the mouse body; andthe third limiting member includes a first end and a second end, and a movement direction of the first end is opposite to a movement direction of the second end; in response to that the mouse body is provided at the mouse base, the third limiting member is configured to rotate, and the first end is located in the second receiving groove; and the second end is located in the second limiting groove, to avoid the mouse body separating from the mouse base.

In an embodiment, the third limiting member is rotatably disposed at the mouse base; the second receiving groove is provided in the mouse base, and the third limiting member is rotatably matched with the mouse base through a connecting shaft;the mouse body is provided with an abutment member; the abutment member is disposed corresponding to the first end, and the abutment member is configured to abut against the first end, to make the first end move towards the second receiving groove;the first end is provided with a first magnet, and the abutment member is configured as a magnet repelling the first magnet; the second end is provided with a second magnet, and an inner wall of the second receiving groove is provided with a first magnetic element magnetically attracted to the second magnet; a magnetic force between the first magnetic element and the second magnet is less than a magnetic force between the abutment member and the first magnet; andthe connecting shaft is provided at a center point of the third limiting member, and a distance between the first magnet and the connecting shaft is equal to a distance between the second magnet and the connecting shaft.

In an embodiment, the limiting portion further includes a first connecting assembly and a second connecting assembly; the first connecting assembly is provided at a front end of the mouse set, and the second connecting assembly is provided at a rear end of the mouse set; the first connecting assembly and the second connecting assembly are configured to limit the mouse body and avoid the mouse body separating from the mouse base along a vertical direction; andthe first connecting assembly includes a first magnetic attraction member and a second magnetic attraction member; the first magnetic attraction member is provided at one of the mouse base and the mouse body; the second magnetic attraction member is provided at the other of the mouse base or the mouse body; the first magnetic attraction member is magnetically connected to the second magnetic attraction member.

In an embodiment, the second connecting assembly includes a third magnetic attachment member and a fourth magnetic attachment member; the third magnetic attachment member is provided at one of the mouse base and the mouse body, and the fourth magnetic attachment member is provided at the other of the mouse base and the mouse body; the third magnetic attachment member is magnetically connected to the fourth magnetic attachment member; andthe first magnetic attachment member, the second magnetic attachment member, the third magnetic attachment member, and the fourth magnetic attachment member are magnets.

In the present application, the mouse body is detachably connected to the mouse base through the limiting portion. On the one hand, it facilitates the separation of the mouse body from the mouse base during use, allowing the mouse body to move freely. On the other hand, when the mouse body is not in use, the mouse body is placed on the mouse base. The limiting portion limits movements of the mouse body, preventing the mouse body separating from the mouse base and thus fixing the mouse body relative to the mouse base when the mouse body is placed at the mouse base. When the mouse body is subjected to impact, the limiting portion can reduce the probability of the mouse body falling when the mouse body tips over or slides, minimizing damage and improving safety. Further, the limiting portion further reduces the need for frequent bending to pick up the mouse, improving user comfort and work efficiency.

### BRIEF DESCRIPTION OF THE DRAWINGS

To more clearly illustrate technical solutions in the embodiments of the present application, the following will briefly introduce the drawings that need to be used in the description of the embodiments. Obviously, the drawings in the following description are only some embodiments of the present application. For those skilled in the art, without creative effort, other drawings can be obtained according to these drawings.

FIG. 1 is a schematic diagram of the overall structure of a mouse set in the present application.

FIG. 2 is a schematic structural diagram of the mouse set with the mouse base prominently displayed, according to an embodiment of the present application.

FIG. 3 is a schematic structural diagram of the mouse set with the mouse body prominently displayed, according to an embodiment of the present application.

FIG. 4 is a cross-sectional diagram of the mouse set with the first limiting assembly prominently displayed in the first state, according to an embodiment of the present application.

FIG. 5 is a cross-sectional diagram of the mouse set with the first limiting assembly prominently displayed in the second state, according to an embodiment of the present application.

FIG. 6 is a cross-sectional diagram of the mouse set with the first limiting assembly prominently displayed in the first state, according to another embodiment of the present application.

FIG. 7 is a cross-sectional diagram of the mouse set with the first limiting assembly prominently displayed in the second state, according to another embodiment of the present application.

FIG. 8 is a schematic diagram showing the assembly of the mouse body and the mouse base of the mouse set in FIG. 1.

FIG. 9 is a schematic diagram of the positioning groove of the mouse body in FIG. 8.

FIG. 10 is a schematic diagram of the positioning post of the mouse base in FIG. 8.

FIG. 11 is a schematic diagram of the internal components of the mouse base in FIG. 8.

FIG. 12 is a schematic structural diagram of the mouse set with the mouse body prominently displayed, according to yet another embodiment of the present application.

FIG. 13 is a schematic structural diagram of the mouse set with the mouse base prominently displayed, according to yet another embodiment of the present application.

FIG. 14 is an enlarged cross-sectional diagram of the mouse set with the mouse body that is prominently displayed and placed on the mouse base, according to an embodiment of the present application.

FIG. 15 is an enlarged cross-sectional diagram of the mouse set with the mouse body that is prominently displayed and separated from the mouse base, according to an embodiment of the present application.

### DETAILED DESCRIPTION OF THE EMBODIMENTS

The present application will be further described in detail below with reference to the accompanying drawings.

To enable those skilled in the art to better understand the present application, the technical solutions in the embodiments of the present application will be clearly and completely described below with reference to the accompanying drawings. Obviously, the described embodiments are only part of the embodiments of the present application, not all of the embodiments. Based on the embodiments in the present application, all other embodiments obtained by those skilled in the art without creative work shall fall within the scope of the present application. Furthermore, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

Besides, the descriptions associated with, e.g., “first”, “second” “third”, “fourth” etc., in the specification, claims, and accompanying drawings of the present application are used to distinguish similar objects and are not necessarily used to describe a specific order or sequence. It should be understood that such data can be interchanged where appropriate, so that the embodiments described herein can be implemented in a sequence other than that illustrated or described herein. Furthermore, the terms “comprise”, “include” or any other variants thereof are intended to cover a non-exclusive inclusion. Thus, a process, method, system, product, or device that includes a series of steps or units is not necessarily limited to those explicitly listed, but may include other steps or units not explicitly listed or inherent to the process, method, system, product, or device.

When a user unintentionally moves the mouse out of the work area or during use, due to external impact, the mouse may become unbalanced and tip over or slide, or even fall off the desktop, requiring it to be flipped or retrieved to continue working, thereby causing inconvenience and reduced work efficiency. Further, when the mouse is dropped and subjected to impact, its internal mechanical components are easily damaged, thereby shortening the mouse lifespan and increasing replacement costs.

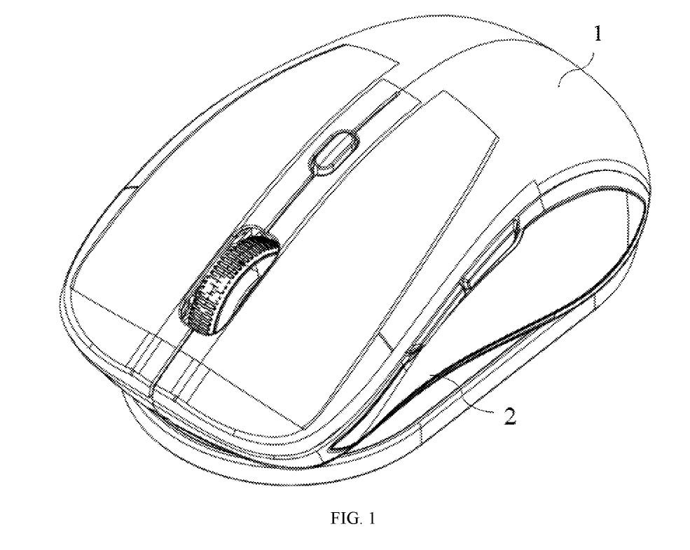

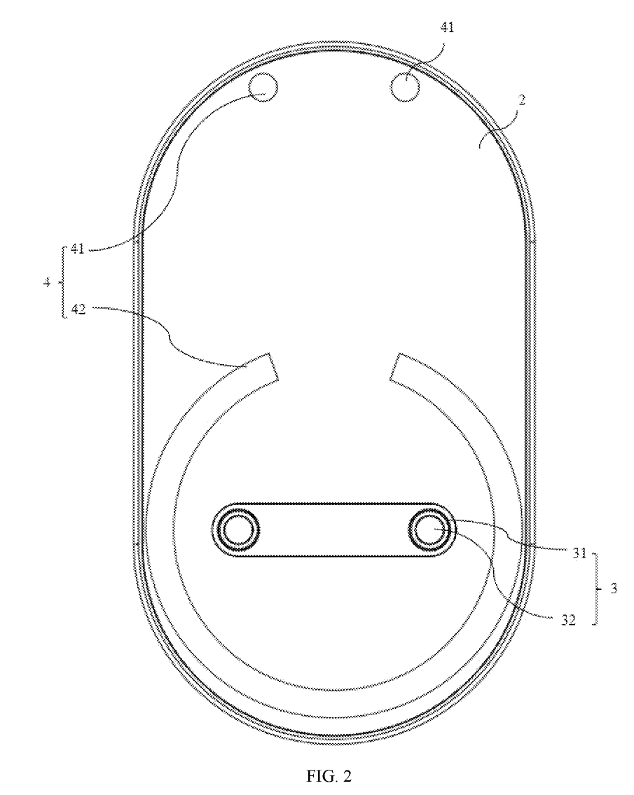

To address the above technical problems, some embodiments of the present application provide a mouse set. As shown in FIG. 1 and FIG. 2, an embodiment illustrates a mouse set in the present application. The mouse set includes: a mouse body 1 configured to input computer instructions; a mouse base 2 provided at a target surface and provided at a bottom of the mouse body 1; a limiting portion. The mouse body 1 is detachably connected to the mouse base 2 through the limiting portion, and the limiting portion is configured to limit movements of the mouse body 1 and avoid the mouse body 1 separating from the mouse base 2.

In the present application, the mouse set, as an electronic device accessory, can be used on electronic devices including tablets, laptops, industrial control equipment, and computers, and the mouse set cooperates with other electronic devices to form an electronic device system. The mouse set is connected to the electronic device to control the electronic device for input operations. Detailed structural features regarding the specific electronic device structure and the connection method of the mouse set, such as wired and wireless connections, are easily understood by those skilled in the art, which will not be repeated here.

In the present application, a mouse body 1 is used for electrical connection with a computer, and a mouse base 2 is provided at the bottom of the mouse body 1. The mouse body 1 is detachably connected to the mouse base 2. On the one hand, this allows the mouse body 1 to be separated from the mouse base 2 as needed during use, facilitating free movement of the mouse body 1. On the other hand, when the mouse body 1 is not in use, the mouse body 1 can be fixed relative to the mouse base 2, which reduces the probability of the mouse body 1 falling when the mouse body 1 tips over or slides.

It should be noted that the target surface mentioned in the present application can refer to the outer surface of the laptop screen when the laptop closed, the surface of the chassis, or the supporting surface of the mouse body 1 (namely, the working surface of the mouse body 1), and the like. The mouse base 2 can be mounted on these supporting surfaces, and the mouse body 1 can be placed on the mouse base 2, thus storing the mouse body 1. Even if the mouse body 1 or the cable is touched, the mouse body 1 will not fall off.

Furthermore, in an embodiment of the present application, the limiting portion may include a first limiting assembly 3 and a second limiting assembly 4. A first limiting assembly 3 limits the mouse body 1 and avoids the mouse body 1 separating from the mouse base 2 in both the horizontal direction and the vertical direction. A second limiting assembly 4 further limits the mouse body 1 and avoids the mouse body 1 separating from the mouse base 2 in both the horizontal direction and the vertical direction. The second limiting assembly 4 further enhances the connection stability between the mouse body 1 and the mouse base 2 when the mouse body 1 is placed on the mouse base 2.

In an embodiment, the first limiting assembly 3 includes a first connecting member 32. One of the mouse base 2 and the mouse body 1 is provided with the first connecting member 32. The mouse base 2 is detachably connected to the mouse body 2 through the first connecting member 32, and the first connecting member 32 limits the movement of the mouse body 1 and avoids the mouse body 1 separating from the mouse base 2. In some embodiments, a first connecting member 32 is provided at a mouse base 2, and a first limiting groove 12 is provided at the mouse body 1 corresponding to the first connecting member 32. The first connecting member 32 is magnetically connected to the mouse body 1, and the end of the first connecting member 32 away from the mouse base 2 is located within the first limiting groove 12. That is, when the first connecting member 32 is magnetically connected to the mouse body 1, the end of the first connecting member 32 away from the mouse base 2 is located within the first limiting groove 12. Through the insertion and engagement of the first connecting member 32 and the first limiting groove 12, the first connecting member 32 provides resistance to the mouse body 1, enhancing the positioning effect of the first connecting member 32 and limiting the movement tendency of the mouse body 1 in the horizontal direction. In addition, the magnetic connection between the first connecting member 32 and the mouse body 1 limits the movement tendency of the mouse body 1 along the vertical direction.

In some other embodiments, a first connecting member 32 is provided at the mouse body 1, and a first limiting groove 12 is provided at the mouse base 2 corresponding to the first connecting member 32. The first connecting member 32 is magnetically connected to the mouse base 2, and the end of the first connecting member 32 away from the mouse body 1 is located within the first limiting groove 12. That is, when the first connecting member 32 is magnetically connected to the mouse body 1, the end of the first connecting member 32 away from the mouse body 1 is located within the first limiting groove 12. For the mouse body 1, the insertion and engagement between the first connecting member 32 and the first limiting groove 12 is achieved through the first limiting groove 12 on the mouse base 2, enhancing the positioning function of the first connecting member 32, so that the first connecting member 32 can resist the mouse body 1 and avoid the mouse body 1 moving horizontally. Besides, the first connecting member 32 is magnetically connected to the mouse body 1 to limit its vertical movement.

It can be understood that when the mouse body 1 is not in use, the mouse body 1 is placed on the mouse base 2. The first connecting member 32 limits movements of the mouse body 1, preventing the mouse body 1 separating from the mouse base 2 and thus fixing the mouse body 1 in place. When the mouse body 1 is subjected to impact, the first connecting member 32 reduces the probability of the mouse body 1 falling when the mouse body 1 tips over or slides, minimizing damage and improving safety. Further, the first connecting member 32 further reduces the need for frequent bending to pick up the mouse, improving user comfort and work efficiency.

The one implementation is that the first connecting member 32 is provided at the mouse base 2 and the first limiting groove 12 is provided at the mouse body 1 corresponding to the first connecting member 32. The other implementation is that the first connecting member 32 is provided at the mouse body 1 and the first limiting groove 12 is provided at the mouse base 2 corresponding to the first connecting member 32. In above implementations, the first connecting member 32 and the first limiting groove 12 are positioned oppositely, but their implementation principles are the same. Therefore, the following explanation uses the implementation that the first connecting member 32 is provided at the mouse base 2 and the first limiting groove 12 is provided at the mouse body 1 corresponding to the first connecting member 32 as an example.

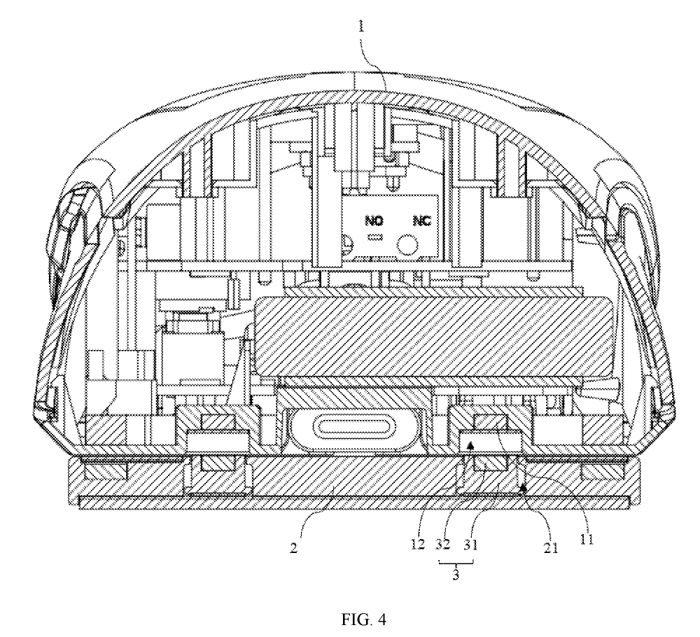

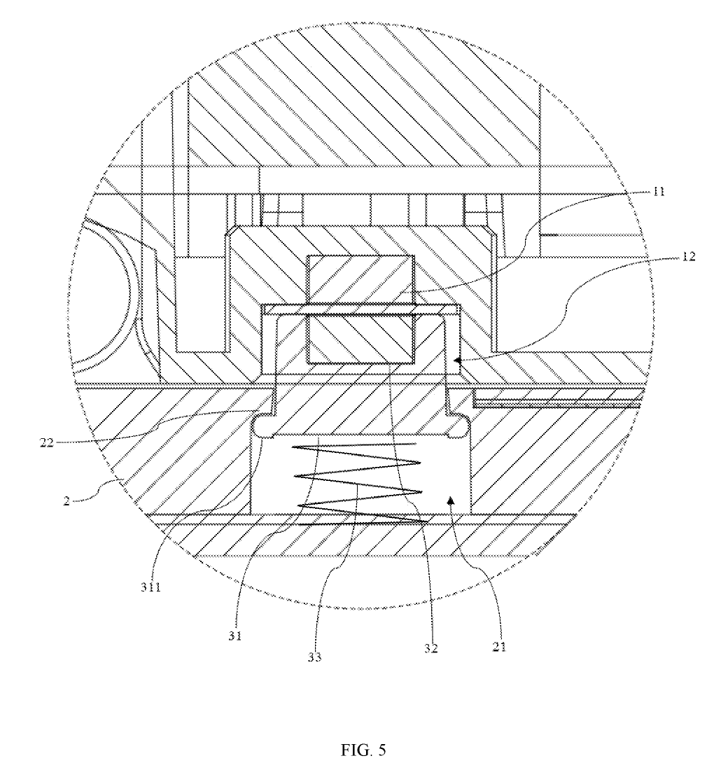

In some embodiments, as shown in FIG. 4 and FIG. 5, the first limiting assembly 3 further includes a limiting post 31. A first connecting member 32 is provided at the side of the limiting post 31 near the mouse body 1. The limiting post 31 is provided at the mouse base 2 and is in sliding fit with the mouse base 2 along the vertical direction. In an embodiment, a limiting ring 311 is provided at the outer peripheral wall of the limiting post 31; the mouse base 2 is provided with a first receiving groove 21, and the limiting post 31 is located in the first receiving groove 21. A flange 22 is provided at the opening of the first receiving groove 21. When the first connecting member 32 is magnetically connected to the mouse body 1, the limiting post 31 is in sliding fit with the inner wall of the first receiving groove along the vertical direction. The limiting ring 311 is abutted against the flange 22. It can be understood that the mouse body 1 is placed on the mouse base 2, and the first connecting member 32 is magnetically connected to the mouse body 1. In this case, the limiting post 31 can slide along the receiving groove 21 and is matched with the receiving groove 21. That is, the limiting post 31 can slide along the vertical direction to connect with the mouse base 2. The limiting ring 311 is abutted against the flange 22, and the flange 22 limits the limiting post 31 and avoid the limiting post 31 sliding out of the receiving groove 21, which is the second state of the first limiting assembly 3, as shown in FIG. 5. When the first limiting assembly 3 is in the second state, if the mouse body 1 tilts or is subjected to the impact, the limiting post 31 will extend out of the first receiving groove 21 and precisely slide into the first limiting groove 12 under the magnetic attraction between the first connecting member 32 and the mouse body 1. The limiting ring 311 is abutted against the flange 22 to prevent the limiting post 31 from sliding out of the first receiving groove 21. The limiting post 31, located in the first limiting groove 12, can prevent the first connecting member 32 separating from the mouse body 1 in the horizontal direction, thus maintaining the magnetic stability of the mouse body 1. It is used to position the mouse body 1, further preventing the mouse body 1 tilting, thereby preventing the mouse body 1 from tipping over or slipping in the horizontal direction, avoiding inconvenience or damage to the device due to tipping over.

When it is necessary to remove the mouse body 1 from the mouse base 2, applying a vertically upward force to the mouse body 1 can separate the first connecting member 32 from the mouse body 1, thus releasing the magnetic attraction. After the first connecting member 32 and the mouse body 1 are released from magnetic attraction, the limiting post 31 slides vertically to return to its original position towards the mouse base 2. In this case, it is referred as the first state of the first limiting assembly 3, as shown in FIG. 4. In the first state, the mouse body 1 is separated from the mouse base 2, and the first limiting assembly 3 releases its limiting effect on the mouse body 1.

Furthermore, when the first connecting member 32 and the mouse body 1 are released from magnetic attraction, in order to allow the limiting post 31 to reset as quickly as possible, a resetting member 33 is provided between the limiting post 31 and the bottom of the first receiving groove 21. The resetting member 33 can be a spring. One end of the resetting member 33 is fixedly connected to the bottom of the first receiving groove 21, and the other end of the resetting member 33 is fixedly connected to the limiting post 31. When the first connecting member 32 and the mouse body 1 are released from magnetic attraction, the resetting member 33 causes the limiting post 31 to move towards the first receiving groove 21 to reset, so that the limiting post 31 is located within the first receiving groove 21.

In some other embodiments, when the first connecting member 32 is provided at the mouse body 1 and the magnetic connection between the first connecting member 32 and the mouse base 2 is released, the limiting post 31 can resist gravity, allowing the limiting post 31 to reset into the receiving groove 21 under the action of the resetting member 33. Due to the restriction imposed by the resetting member 33 on the limiting post 31, the limiting post 31 remains positioned within the receiving groove 21 and does not engage in sliding contact with the groove wall of the receiving groove 21. In an embodiment, the end face of the limiting post 31 near the mouse base 2 aligns flush with the bottom surface of the mouse body 1, so that when the mouse body 1 is separated from the mouse base 2 and used independently, the limiting post 31 will not affect the user experience of the mouse body 1.

To further enhance the magnetic stability between the mouse body 1 and the mouse base 2, the first limiting assembly further includes a second connecting member 11. The second connecting member 11 is positioned within the first limiting groove 12 and corresponds to the first connecting member 32. The first connecting member 32 is magnetically connected to the second connecting member 11. The cooperation between the first connecting member 32 and the first limiting groove 12 further allows for quick alignment between the mouse body 1 and the mouse base 2, improving the efficiency of the rapid and precise connection between the first limiting assembly 3 and the second connecting member 11 in the positioning groove 12.

In some embodiments, a first connecting member 32 is provided at the mouse base 2, and a second connecting member 32 is provided at the mouse body 1. The second connecting member 11 is magnetically connected to the first connecting member 32 to enhance the magnetic stability between the mouse body 1 and the mouse base 2. In other embodiments, the first connecting member 32 is provided at the mouse body 1, and the second connecting member 32 is provided at the mouse base 2. The second connecting member 11 is magnetically connected to the first connecting member 32 to enhance the magnetic stability between the mouse body 1 and the mouse base 2. In other embodiments, a component for magnetic attraction of the first connecting member 32 can be provided at the mouse body 1, so that the same magnetic connection between the first connecting member 32 and the mouse body 1 can still be achieved without setting the second connecting member 11.

The first connecting member 32 can be a magnet, and the second connecting member 11 can be an iron piece, thereby allowing for magnetic attraction between the first connecting member 32 and the second connecting member 11. Or, the first connecting member 32 is an iron piece, and the second connecting member 11 is a magnet, allowing for magnetic attraction between the first connecting member 32 and the second connecting member 11. Or, both the first connecting member 32 and the second connecting member 11 can be magnets, thereby allowing for magnetic attraction between the first connecting member 32 and the second connecting member 11. Due to the magnetic force, the mouse body 1 will not slip out of the mouse base 2, and it just needs to align the first connecting member 32 and the second connecting member 11 without additional mechanical connecting members, thereby making installation convenient.

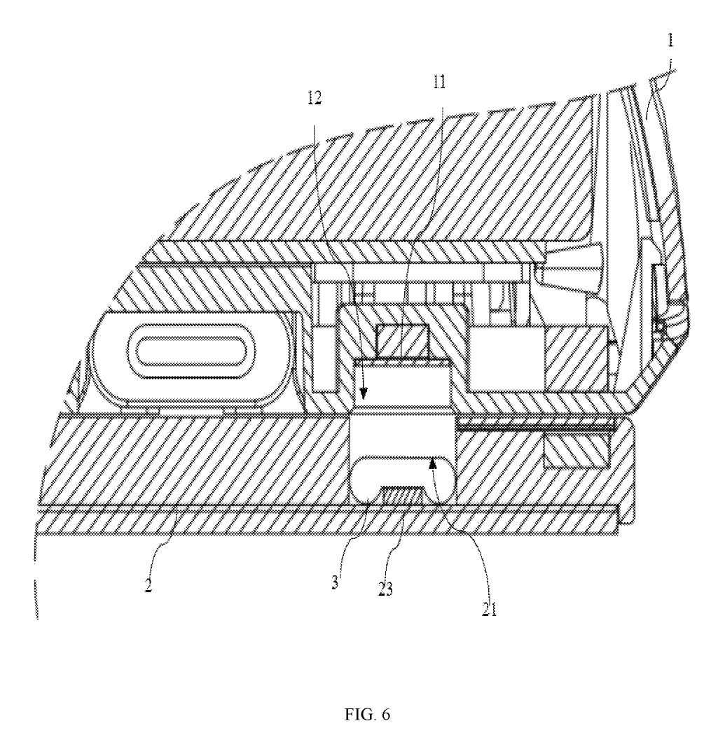

In other embodiments, as shown in FIG. 6 and FIG. 7, the mouse base 2 is provided with a first receiving groove 21. The end of the first connecting member 32 away from the mouse body 1 is located within the first receiving groove 21 and is rotatably matched with the mouse base 2. In an embodiment, a protrusion 23 is provided at the bottom of the first receiving groove 21. When the first connecting member 32 is magnetically connected to the mouse body 1, the protrusion 23 limits the sliding of the end of the first connecting member 32 away from the mouse body 1, so that the first connecting member 32 is rotatably matched with the bottom of the first receiving groove 21, and the end of the first connecting member 32 away from the mouse base 2 is located within the first limiting groove 12. In this embodiment, the first connecting member 32 can be a hinge magnet. Understandably, the mouse body 1 is placed on the mouse base 2. The protrusion 23 prevents one end of the first connecting member 32 from sliding along the bottom of the receiving groove 21. Under the magnetic attraction between the first connecting member 32 and the mouse body 1, the first connecting member 32 rotates around one end of the first connecting member 32, causing one end of the first connecting member 32 near the mouse body 1 to gradually extend out of the first receiving groove 21, then the rotation stops when the end of the first connecting member 32 near the mouse body 1 is positioned within the first limiting groove 12, and it is referred as the second state of the first limiting assembly 3, as shown in FIG. 7. When the first limiting assembly 3 is in the second state, if the mouse body 1 tilts or is subjected to an impact, the first connecting member 32 will extend out of the receiving groove 21 and will be located within the limiting groove 12, so that the first connecting member 32 can position the mouse body 1, prevent the mouse body 1 from tilting, avoid the mouse body 1 tilting or slipping in the horizontal direction, and avoid operational inconvenience or damage to the device.

To remove the mouse body 1 from the mouse base 2, it just needs to apply a vertical upward force to the mouse body 1, causing the first connecting member 32 and the second connecting member 11 to separate from each other and release the magnetic attraction. After the magnetic attraction between the first connecting member 32 and the second connecting member 11 is released, the first connecting member 32 rotates around the end of the first connecting member 32 away from the mouse body 1, and the end of the first connecting member 32 near the mouse body 1 withdraws from the first limiting groove 12 and resets towards the mouse base 2 until the first connecting member 32 is laterally positioned in the first receiving groove 21. In this case, it is referred as the first state of the first limiting assembly 3, as shown in FIG. 6. In the first state of the first limiting assembly 3, the mouse body 1 separates from the mouse base 2, and the first limiting assembly 3 releases the limit on the mouse body 1.

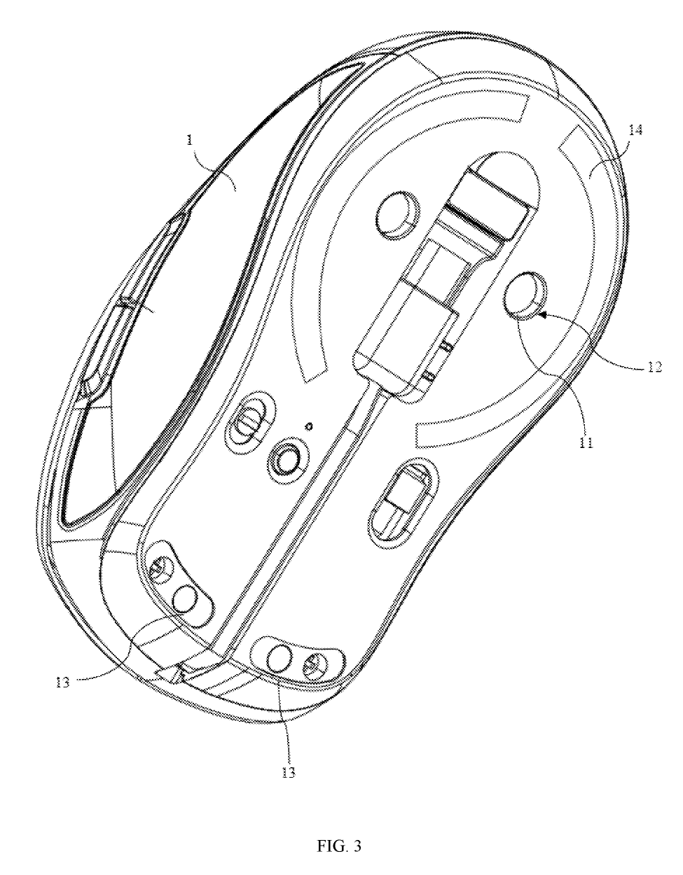

As shown in FIG. 2 and FIG. 3, the second limiting assembly 4 is fixedly mounted at either the mouse base 2 or the mouse body 1, to avoid the mouse body 1 separating from the mouse base 2 both in the horizontal direction and the vertical direction. That is, the second limiting assembly 4 can be fixedly mounted at the mouse base 2, or the second limiting assembly 4 can be fixedly mounted at the mouse body 1, and the implementation principle is the same. Therefore, the following explanation uses the example of the second limiting assembly 4 being fixedly mounted at the mouse base 2. The second limiting assembly 4 includes a first limiting member 41 and a second limiting member 42. The first limiting member 41 and the second limiting member 42 are respectively provided at both ends of the mouse base 2. The mouse body 1 is provided with a third connecting member 13 and a fourth connecting member 14. The third connecting member 13 is disposed corresponding to the first limiting member 41, and the first limiting member 41 is magnetically connected to the third connecting member 13. The fourth connecting member 14 is disposed corresponding to the second limiting member 42, and the second limiting member 42 is magnetically connected to the fourth connecting member 14. The first limiting member 41 and the third connecting member 13 have the same shape and size. The second limiting member 42 and the fourth connecting member 14 have the same shape and size. Both the second limiting member 42 and the fourth connecting member 14 are arranged in the arc shape. The fourth connecting member 14 is formed by combining two arc shapes. The first limiting member 41, the second limiting member 42, the third connecting member 13 and the fourth connecting member 14 can be magnets. Understandably, the first limiting member 41 cooperates with the third connecting member 13 to fix the front end of the mouse body 1 and the front end of the mouse base 2. There are two first limiting members 41 and two third connecting members 13. Two first limiting members 41 and two third connecting members 13 are provided at both sides of the central axis of the mouse body 1 and are symmetrically arranged. The second limiting member 42 cooperates with the fourth connecting member 14 to fix the rear end of the mouse body 1 and the rear end of the mouse base 2. The shapes of the second limiting member 42 and the fourth connecting member 14 are adapted to the shape of the rear end of the mouse body 1, which enhances the adsorption force between the rear end of the mouse body 1 and the rear end of the mouse base 2, so as to ensure that the mouse body 1 can be placed stably and accurately on the mouse base 2.

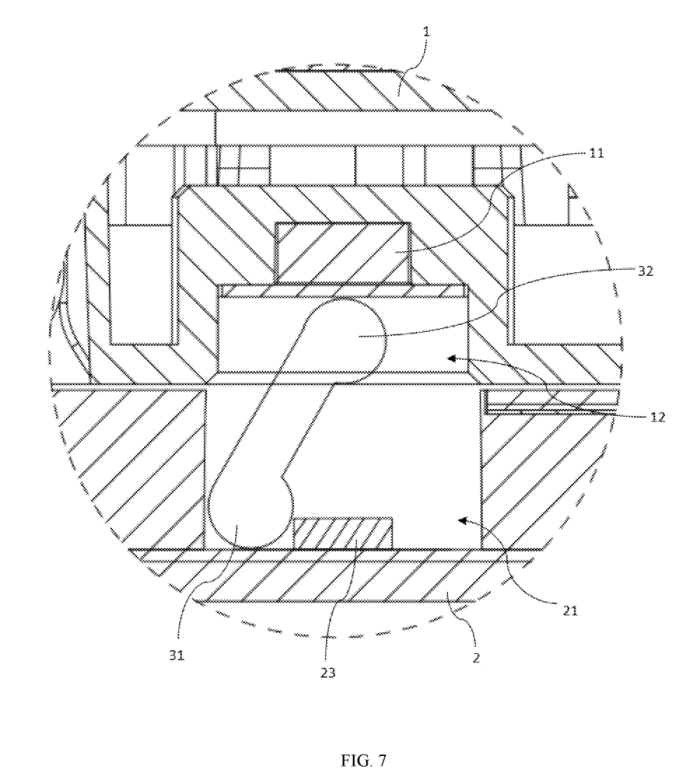

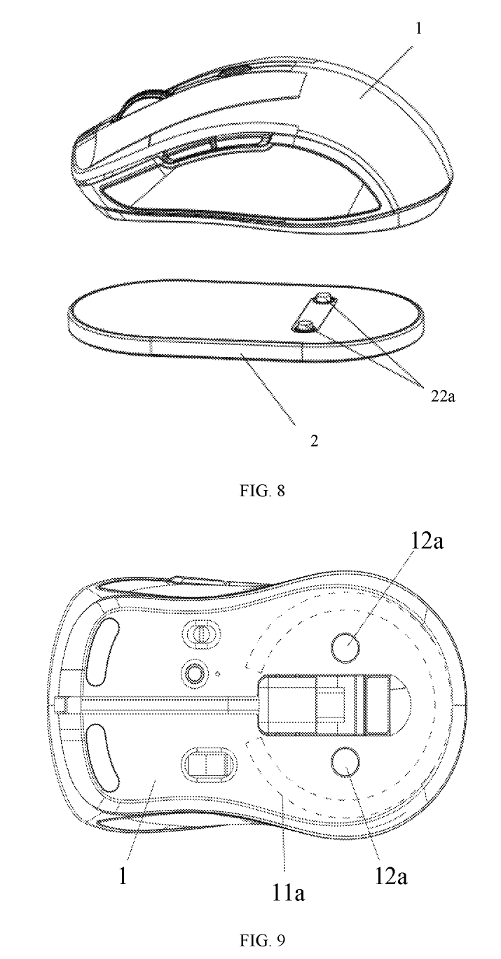

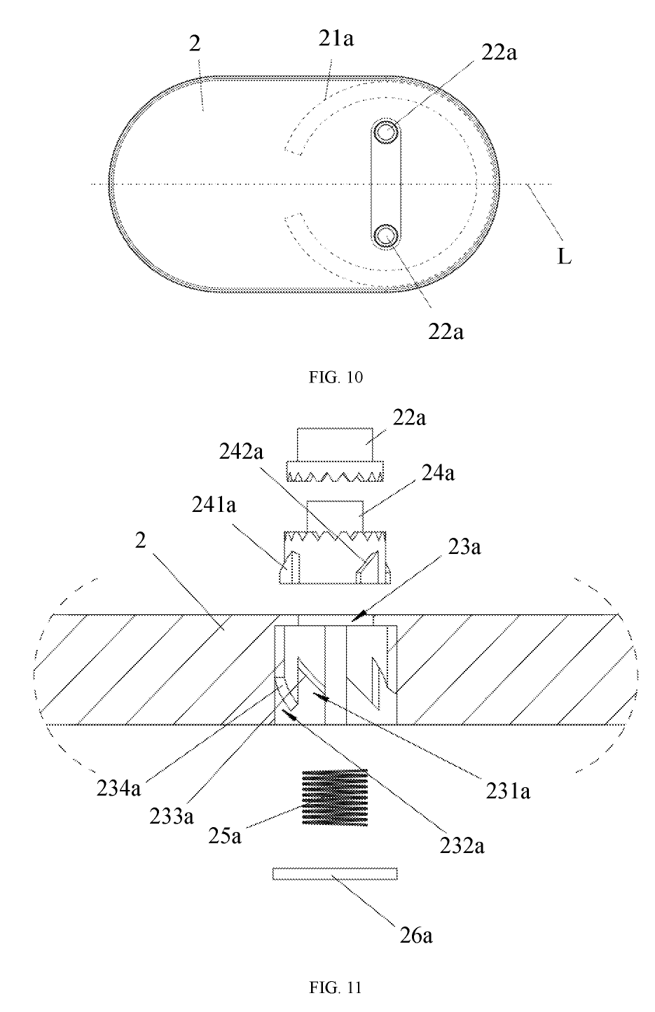

In addition, in other embodiments of the present application, as shown in FIG. 1 and FIG. 8-FIG. 11, the limiting portion may include: a first attachment member 11a and a second attachment member 21a. The first attachment member 11a may be provided inside the mouse body 1, or may be provided at the bottom the mouse body 1, and a positioning groove 12a is provided at the bottom the mouse body 1. The second attachment member 21a is provided at the mouse base 2, and a positioning post 22a is movably mounted on the mouse base 2. The end of the positioning post 22a can extend out of the top of the mouse base 2 or retract inside the mouse base 2. When the end of the positioning post 22a extends out of the top of the mouse base 2, the positioning groove 12a connects to the end of the positioning post 22a, and the first and second attachment members 11a and 21a adhere to each other, thus connecting the mouse body 1 to the mouse base 2.

Based on the above technical solution, this mouse set includes a mouse body 1 and a mouse base 2. The mouse body 1 is used as a device for inputting computer instructions, and the mouse base 2 is used to mount on a target surface. When using the mouse body 1 to input instructions to devices such as computers, the mouse body 1 and the mouse base 2 are separate. The positioning post 22a on the mouse base 2 can retract into the mouse base 2, preventing the positioning post 22a from obstructing other user activities. When the mouse body 1 is not in use, the end of the positioning post 22a can extend out from the top of the mouse base 2. The positioning groove 12a at the bottom of the mouse body 1 can connect to the end of the positioning post 22a. Then the first attachment member 11a and the second attachment member 21a are attached, connecting the mouse body 1 to the mouse base 2, so that the mouse body 1 is placed on the mouse base 2, making the mouse body 1 less likely to be accidentally touched and dropped, thus preventing damage from a fall.

Furthermore, this mouse set has another application scenario, which is further described in the present application. When carrying a laptop by hand, the mouse is usually clipped between the keyboard and the display screen. Sometimes, if not careful, the keyboard and display screen sides can damage the mouse, causing the mouse to malfunction. Therefore, in this scenario, the mouse base 2 can be attached to the side of the laptop away from the display screen. This allows the laptop to be fully closed, with the mouse base 2 facing upwards. The mouse body 1 can then be placed on the mouse base 2, preventing damage to the mouse body 1 during transporting.

In the aforementioned scenario of carrying a laptop, based on user’s behavioral habits, laptops are almost never carried parallel to the horizontal plane, as this would require a lot of effort. Essentially, the laptop is tilted at a more effortless angle. Correspondingly, the mouse base 2 and mouse body 1 are also tilted relative to the horizontal plane. When the first attachment member 11a and the second attachment member 21a are attached, the positioning post 22a at the mouse base 2 needs to extend beyond the top of the mouse base 2 and insert into the positioning groove 12a of the mouse body 1, to further ensure that the mouse body 1 does not detach from the mouse base 2. However, during normal use of the laptop, if the positioning post 22a extends out of the surface of the mouse base 2, the positioning post 22a may be touched by the user, causing the laptop to shift position. The user would then need to spend time readjusting the laptop position. Therefore, when the mouse body 1 is in use, the mouse body 1 is not placed on the mouse base 2. In this case, the positioning post 22a at the mouse base 2 retracts into the mouse base 2 to avoid obstructing other user operations.

In some embodiments, the positioning post 22a is rotatably mounted on the mouse base 2. The positioning post 22a can rotate relative to the mouse base 2, extending out from the top of the mouse base 2 or retracting into the mouse base 2. A groove can be formed at the top of the mouse base 2, and the positioning post 22a is rotatably connected to the groove through a pivot. When the end of the positioning post 22a extends out from the top of the mouse base 2, there can be a slight locking between the positioning post 22a and the groove to ensure the mouse body 1 is placed securely on the mouse base 2.

In some embodiments, the positioning post 22a can be pressed to pop out from the top of the mouse base 2 or retract into the mouse base 2.

For example, a push-push pressing structure can be used to pop out the positioning post 22a from the top of the mouse base 2 or retract the positioning post 22a into the mouse base 2.

In an embodiment, a mounting hole 23a is provided inside the mouse base 2. A push-push pressing structure is located inside the mounting hole 23a. The push-push pressing structure includes an indexing cylinder, a rotating cylinder 24a, and an elastic member 25a. The inner sidewall of the indexing cylinder has multiple staggered deep grooves 231a and shallow grooves 232a. The rotating cylinder 24a is located inside the indexing cylinder. The outer periphery of the rotating cylinder 24a has multiple engaging teeth 241a. The two ends of the elastic member 25a are respectively connected to the inside of the rotating cylinder 24a and the inner wall of the mouse base 2. A positioning post 22a is connected to the rotating cylinder 24a. When the engaging teeth 241a are connected to the inside of the deep groove 231a, the positioning post 22a retracts inside the mouse base 2. When the engaging teeth 241a are connected to the inside of the shallow groove 232a, the positioning post 22a pops out from the top of the mouse base 2.

Both the deep groove 231a and the shallow groove 232a have pointed lower ends, as does the upper end of the engaging tooth 241a. The deep groove 231a has a first inclined surface 233a, the shallow groove 232a has a second inclined surface 234a, and the engaging tooth 241a has a third inclined surface 242a. Each time the positioning post 22a is pressed, the first inclined surface 233a of the deep groove 231a and the third inclined surface 242a of the engaging tooth 241a disengage until the upper end of the engaging tooth 241a touches and passes over the lower end of the deep groove 231a; or, the second inclined surface 234a of the shallow groove 232a and the third inclined surface 242a of the engaging tooth 241a disengage until the upper end of the engaging tooth 241a touches and passes over the lower end of the shallow groove 232a. In this case, the elastic member 25a is compressed. When the positioning post 22a is released, the elastic member 25a rebounds, and the rotating cylinder 24a tends to move upwards. The upper end of the engaging tooth 241a enters the inner of the shallow groove 232a. Due to the presence of the second inclined surface 234a of the shallow groove 232a, the rotating cylinder 24a is driven to rotate until the second and third inclined surfaces 234a are fully attached to each other. In this case, the engaging tooth 241a is connected to the inside of the shallow groove 232a, and the positioning post 22a pops out from the top of the mouse base 2. Or, the upper end of the engaging tooth 241a enters the inner of the deep groove 231a. Due to the presence of the first inclined surface 233a of the deep groove 231a, the rotating cylinder 24a is driven to rotate until the first inclined surface 233a and the third inclined surface 242a are fully attached to each other. In this case, the engaging tooth 241a connects to the inside of the deep groove 231a, and the positioning post 22a retracts into the mouse base 2. Thus, pressing the positioning post 22a allows for switching between popping out and retracting the positioning post 22a.

In some embodiments, to optimize the component structure, the present application designs the indexing cylinder and the mouse base 2 as a single molded structure, with the deep groove 231a and the shallow groove 232a directly formed on the inner sidewall of the mounting hole 23a.

In some embodiments, the mounting hole 23a can be a blind hole with the elastic member 25a directly abutting against the bottom of the mounting hole 23a. Or, the mounting hole 23a can be a through hole with a blocking member 26a connected to the bottom of the mounting hole 23a, and the elastic member 25a is abutted against the blocking member 26a.

In some embodiments, the elastic member 25a includes a spring or a component commonly found in the related art capable of elastic deformation and providing elastic force during deformation.

In some embodiments, the mouse base 2 is provided with multiple positioning posts 22a, and correspondingly, the bottom of the mouse body 1 is provided with multiple positioning grooves 12a. The multiple positioning grooves 12a of the mouse body 1 are connected to the positioning posts 22a of the mouse base 2. This prevents the mouse body 1 from rotating when the mouse body 1 is placed on the mouse base 2, allowing the mouse body 1 to be placed more stably on the mouse base 2.

Furthermore, to strengthen the connection between the mouse body 1 and the mouse base 2, multiple positioning posts 22a are symmetrically distributed about a straight line L. Correspondingly, the second attachment member 21a is further symmetrical about the straight line L. The first attachment member 11a and the second attachment member 21a are correspondingly arranged. The first attachment member 11a includes a magnetic member, and the second attachment member 21a includes a magnetic member and a non-magnetic component that can be magnetically attracted. Or, the first attachment member 11a includes a magnetic member and a non-magnetic component that can be magnetically attracted, and the second attachment member 21a includes a magnetic member. The second attachment member 21a can be arranged around the positioning post 22a.

In some embodiments, the bottom of the mouse base 2 is provided with an adhesive layer, such as by directly applying glue to the bottom of the mouse base 2 to form an adhesive layer, or by other methods in the related art. Furthermore, the bottom of the mouse base 2 may further be provided with a magnetic attachment member, or the bottom of the mouse base 2 may be detachably connected to a target surface via a quick-release structure. The target surface mentioned in the present application can refer to the outer surface of the laptop screen when the laptop is closed, the surface of the chassis, or the supporting surface of the mouse body 1, namely, the working surface of the mouse body 1, and the like. The mouse base 2 can be mounted on these supporting surfaces, and the mouse body 1 can be placed on the mouse base 2 to store the mouse body 1. Even if the mouse body 1 or its cable is touched, the mouse body 1 will not fall off.

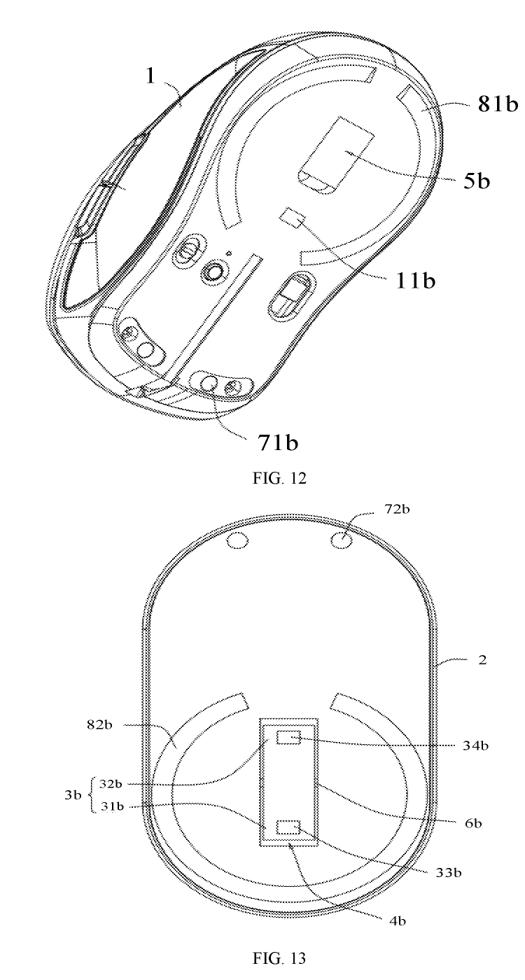

Further, as shown in FIG. 12 and FIG. 13, in some embodiments of the present application, the limiting portion may include a third limiting member 3b. To reduce the probability of the mouse body 1 falling due to tipping or sliding, one of the mouse base 2 and the mouse body 1 is provided with a third limiting member 3b and a second receiving groove 4b, and the other of the mouse base 2 and the mouse body 1 is provided with a second limiting groove 5b. The third limiting member 3b is rotatably mounted at either the mouse base 2 or the mouse body 1. The third limiting member 3b includes a first end 31b and a second end 32b, with the movement direction of the first end 31b being opposite to the movement direction of the second end 32b. When the mouse body 1 is placed on the mouse base 2, the third limiting member 3b rotates, and the first end 31b is located in the second receiving groove 4b, while the second end 32b is located in the second limiting groove 5b, thus preventing the mouse body 1 separating from the mouse base 2. Understandably, when the mouse body 1 is placed on the mouse base 2, the mouse body 1 applies a force to the first end 31b, causing the first end 31b to move towards the second receiving groove 4b. In this case, the third limiting member 3b rotates, thereby causing the second end 32b to move in the direction opposite to the movement direction of the first end 31b. That is, the second end 32b gradually moves closer to the second limiting groove 5b until the second end 32b is disposed inside the second limiting groove 5b. The second end 32b inside the second limiting groove 5b is abutted against the second limiting groove 5b, thereby avoiding the mouse body 1 separating from the mouse base 2, thus fixing the mouse body 1 relative to the mouse base 2 when the mouse body 1 is placed on the mouse base 2. When the mouse body 1 is not in use, placing the mouse body 1 on the mouse base 2 can reduce probability that the mouse body 1 tips over or slides, thereby reducing damage caused by dropping and improving mouse safety. It further eliminates the need for frequent bending to pick up the mouse, enhancing user comfort and work efficiency.

Correspondingly, when the mouse body 1 moves away from the mouse base 2, the force applied to the first end 31b gradually decreases, causing the first end 31b to move away from the second receiving groove 4b. In this case, the third limiting member 3b rotates, causing the second end 32b to move in the direction opposite to the movement direction of the first end 31b. That is, the second end 32b gradually moves away from the second limiting groove 5b until the second end 32b is completely separated from the second limiting groove 5b. This releases the limitation between the mouse body 1 and the mouse base 2, allowing the mouse body 1 to separate from the mouse base 2, and making the mouse body 1 move freely during use.

In this embodiment, the third limiting member 3b and the second receiving groove 4b are provided at the mouse base 2, the third limiting member 3b is rotatably mounted on the mouse base 2, and the second limiting groove 5b is provided at the mouse body 1. In other embodiments, the third limiting member 3b and the second receiving groove 4b can be provided at the mouse body 1, the third limiting member 3b is rotatably mounted on the mouse body 1, and the second limiting groove 5b is provided at the mouse base 2. Since the principles of the two implementations are the same, the present application uses the configuration of providing the third limiting member 3b and the second receiving groove 4b at the mouse base 2 as an example for description, and the configuration of providing the third limiting member 3b and the second receiving groove 4b at the mouse body 1 will not be described in detail.

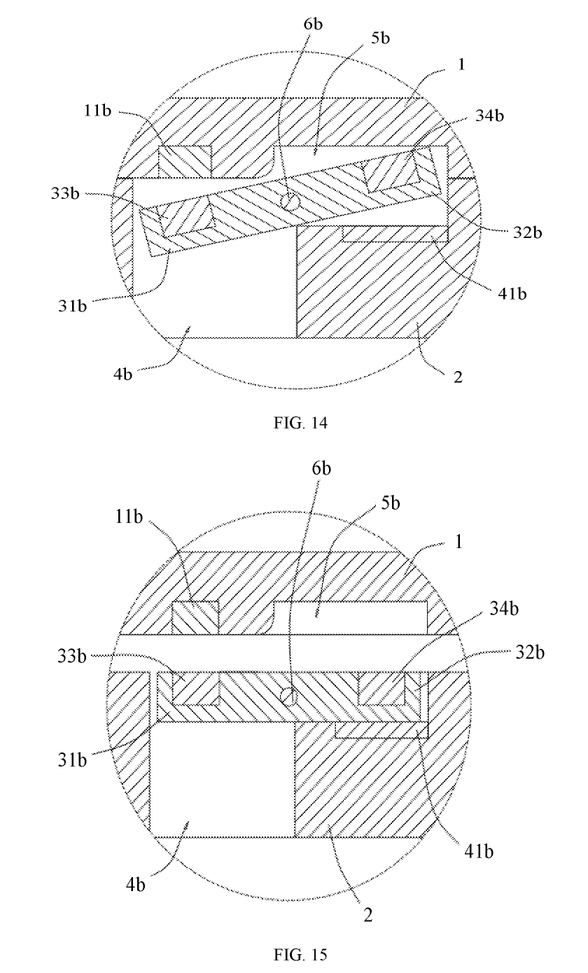

As shown in FIG. 14 and FIG. 15, in this embodiment, the depth of the second receiving groove 4b of the mouse base 2 is sufficient to accommodate the rotation of the third limiting member 3b. To ensure the flatness of the end face of the mouse base 2, the third limiting member 3b is positioned within the second receiving groove 4b. The third limiting member 3b is rotatably matched with the mouse base 2 via a connecting shaft 6b, and the connecting shaft 6b is located at the center point of the third limiting member 3b. The distance between the first end 31b and the connecting shaft 6b is equal to the distance between the second end 32b and the connecting shaft 6b. Therefore, when the mouse body 1 moves away from the mouse base 2, the heights of the first end 31b and the second end 32b are the same. When the mouse body 1 applies a force to the first end 31b, the torque between the first end 31b and the connecting shaft 6b is equal to the torque between the second end 32b and the connecting shaft 6b. The movement distances of the first end 31b and the second end 32b are the same. The depth of the first end 31b entering the second receiving groove 4b is the same as the depth of the second end 32b extending out of the second receiving groove 4b and being located in the second limiting groove 5b. This allows the second end 32b to position the mouse body 1, preventing further tilting of the mouse body 1 and thus limiting the horizontal tilting or slippage, preventing operational inconvenience or damage.

In an embodiment, the mouse body 1 is provided with an abutment member 11b, which is disposed corresponding to the first end 31b. The abutment member 11b is used to abut against the first end 31b, to make the first end move towards the second receiving groove 4b. When the mouse body 1 is placed on the mouse base 2, the abutment member 11b is abutted against the first end 31b, to make the first end move towards the second receiving groove 4b. In addition, the second end 32b moves the same distance towards the second limiting groove 5b, causing the second end 32b to be positioned in the second limiting groove 5b and abutted against the second limiting groove 5b, thereby avoiding the mouse body 1 separating from the mouse base 2.

Furthermore, in order to keep the bottom surface of the mouse body 1 flat and facilitate the use of the mouse body 1, the mouse body 1 is provided with an avoidance groove for accommodating the abutment member 11b. In some embodiments, the abutment member 11b can be folded and stored in the avoidance groove by rotation, or the abutment member 11b can be stored in the avoidance groove by sliding. In this embodiment, the abutment member 11b is a magnet. The abutment member 11b is located in the avoidance groove, and the end face of the abutment member 11b facing the first end 31b aligns flush with the end face of the mouse body 1. The second end 32b is provided with a first magnet 33b, and the abutment member 11b is configured as a magnet that repels the first magnet 33b. Understandably, since the abutment member 11b repels the first magnet 33b, when the mouse body 1 is placed at the mouse base 2, the abutment member 11b gradually approaches the first magnet 33b. The abutment member 11b then repels the first magnet 33b, causing the third limiting member 3b to rotate around the connecting shaft 6b. The first end 31b gradually enters the second receiving groove 4b, while the second end 32b extends out of the receiving groove 4b and is located within the second limiting groove 5b, as shown in FIG. 14. Correspondingly, when the mouse body 1 moves away from the mouse base 2, the repulsive force of the abutment member 11b on the first magnet 33b decreases, causing the first end 31b to gradually return to its original position. In addition, the second end 32b separates from the second limiting groove 5b and further returns to its original position, as shown in FIG. 15.

Furthermore, when the repulsive force between the abutment member 11b and the first end 31b is released, in order to allow the third limiting member 3b to quickly reset and achieve a flattened effect, the second end 32b is provided with a second magnet 34b, and the inner wall of the second receiving groove 4b is provided with a first magnetic element 41b that is magnetically attracted to the second magnet 34b. The magnetic force between the first magnetic element 41b and the second magnet 34b is less than the magnetic force between the abutment member 11b and the first magnet 33b, and the distance between the first magnet 33b and the connecting shaft 6b is equal to the distance between the second magnet 34b and the connecting shaft 6b. In this embodiment, the first magnetic element 41b can be an iron piece. When the third limiting member 3b is in a flat state, the first magnetic element 41b and the second magnet 34b are attracted to each other. Understandably, when the mouse body 1 is placed on the mouse base 2, since the magnetic force between the first magnetic element 41b and the second magnet 34b is less than the magnetic force between the abutment member 11b and the first magnet 33b, the first end 31b gradually enters the second receiving groove 4b under the magnetic force between the abutment member 11b and the first magnet 33b. In addition, due to the separation of the first magnetic element 41b and the second magnet 34b, the second end 32b gradually enters the second limiting groove 5b. When the mouse body 1 moves away from the mouse base 2, the second end 32b gradually moves away from the second limiting groove 5b. In addition, the second magnet 34b moves towards the second receiving groove 4b under the magnetic force of the first magnetic element 41b. When the second magnet 34b is attached to the first magnetic element 41b, the second end 32b remains stationary, and the first end 31b also remains stationary, thereby achieving a flat effect of the third limiting member 3b. By setting the abutment member 11b, the first magnet 33b, the second magnet 34b, and the magnetic element 41b in the present application, not only the manufacturing process of the mouse set can be simplified and costs can be reduced, but also operations are easy and a stable structure with high reliability can be achieved.

As shown in FIG. 12 and FIG. 13, to further enhance the magnetic stability between the mouse body 1 and the mouse base 2, the mouse set further includes a first connecting assembly 7b and a second connecting assembly 8b. The first connecting assembly 7b is located at the front end of the mouse set, and the second connecting assembly 8b is located at the rear end of the mouse set. Both the first connecting assembly 7b and the second connecting assembly 8b can be used to avoid the mouse body 1 separating from the mouse base 2 along the vertical direction, and can further enable quick alignment between the mouse body 1 and the mouse base 2, thereby improving the efficiency of the rapid and precise connection between the second end 32b and the second limiting groove 5b.

In an embodiment, the first connecting assembly 7b includes a first magnetic attachment member 71b and a second magnetic attachment member 72b. The first magnetic attachment member 71b is provided at one of the mouse base 2 and the mouse body 1. The second magnetic attachment member 72b is provided at the other of the mouse base 2 and the mouse body 1. The first magnetic attachment member 71b is magnetically connected to the second magnetic attachment member 72b. In some embodiments, the first magnetic attachment member 71b is provided at the mouse base 2, and the second magnetic attachment member 72b is provided at the mouse body 1. The first magnetic attachment member 71b is magnetically connected to the second magnetic attachment member 72b, to enhance the magnetic stability between the mouse body 1 and the mouse base 2. In other embodiments, the first magnetic attachment member 71b is provided at the mouse body 1, and the second magnetic attachment member 72b is provided at the mouse base 2. The first magnetic attachment member 71b is magnetically connected to the second magnetic attachment member 72b, to enhance the magnetic stability between the mouse body 1 and the mouse base 2. No additional mechanical connecting member is required; simply aligning the first magnetic attachment member 71b and the second magnetic attachment member 72b is sufficient for easy installation. In other embodiments, the first magnetic attachment member 71b can be magnetically attached to the mouse body 1 by setting a component inside the mouse body 1 for the first magnetic attachment member 71b to be magnetically attached, so that it is not necessary to provide the second magnetic attachment member 72b, and the same magnetic connection between the first magnetic attachment member 71b and the mouse body 1 can still be achieved.

The second connecting assembly 8b includes a third magnetic attachment member 81b and a fourth magnetic attachment member 82b. The third magnetic attachment member 81b is provided at one of the mouse base 2 and the mouse body 1, and the fourth magnetic attachment member 82b is provided at the other of the mouse base 2 and the mouse body 1. The third magnetic attachment member 81b is magnetically connected to the fourth magnetic attachment member 82b. In some embodiments, the third magnetic attachment member 81b is provided at the mouse base 2, and the fourth magnetic attachment member 82b is provided at the mouse body 1. The third magnetic attachment member 81b is magnetically connected to the fourth magnetic attachment member 82b, to enhance the magnetic stability between the mouse body 1 and the mouse base 2. In other embodiments, the third magnetic attachment member 81b is provided at the mouse body 1, and the fourth magnetic attachment member 82b is provided at the mouse base 2. The third magnetic attachment member 81b is magnetically connected to the fourth magnetic attachment member 82b, to enhance the magnetic stability between the mouse body 1 and the mouse base 2.

In this embodiment, the first magnetic attachment member 71b and the second magnetic attachment member 72b have the same shapes and the same sizes. The third magnetic attachment member 81b and the fourth magnetic attachment member 82b are matched with each other in shape and size. Furthermore, the third magnetic attachment member 81b and the fourth magnetic attachment member 82b are generally arc-shaped. The first magnetic attachment member 71b, the second magnetic attachment member 72b, the third magnetic attachment member81b, and the fourth magnetic attachment member 82b can be magnets. Understandably, the first magnetic attachment member 71b matches with the second magnetic attachment member 72b, thereby fixing the front end of the mouse body 1 to the front end of the mouse base 2. There are two first magnetic attachment members 71b and two second magnetic attachment members 72b. Two first magnetic attachment members 71b and two second magnetic attachment members 72b are disposed symmetrically on both sides of the central axis of the mouse body 1. The third magnetic attachment member 81b matches with the fourth magnetic attachment member 82b, thereby fixing the rear end of the mouse body 1 to the rear end of the mouse base 2. Each shape of the third magnetic attachment member 81b and the fourth magnetic attachment member 82b matches with the shape of the rear end of the mouse body 1, thereby enhancing the adhesive force between the rear end of the mouse body 1 and the rear end of the mouse base 2, so as to ensure that the mouse body 1 can be placed stably and accurately at the mouse base 2.

In the description of the present application, the term of “several” means one or more; the terms of “multiple” means two or more; the terms of “greater than”, “less than”, “exceeding” are understood to exclude the number itself; the terms of “above”, “below”, and “within” are understood to include the number itself. The terms of “first” and “second”" in the description are used for distinguishing technical features and should not be construed as indicating or implying relative importance, or implicitly indicating the number of technical features indicated, or implicitly indicating the order of the technical features indicated.

In the description of the present application, unless otherwise expressly defined, terms such as “set”, “install”, and “connect” should be interpreted broadly. Those skilled in the art can reasonably determine the specific meaning of the above terms in the present application based on the specific contents of the technical solutions.

In the description of the present application, the terms “an embodiment”, “some embodiments”, “illustrative embodiment”, “example”, “specific example”, “some examples”, and the like, refer to specific features, structures, materials, or characteristics described in connection with that embodiment or example, which should be included in at least one embodiment or example of the present application. In this specification, the illustrative expressions of the above terms do not necessarily refer to the same embodiment or example. Furthermore, the specific features, structures, materials, or characteristics described may be combined in any suitable manner in one or more embodiments or examples.

In summary, the above embodiments are only used to illustrate the technical solutions of the present application, and do not limit the scope of the present application thereto. Although the present application has been described in detail with reference to the foregoing embodiments, those skilled in the art should understand that modifications can still be made to the technical solutions described in the foregoing embodiments, or equivalent substitutions can be made to some of the technical features; and these modifications or substitutions do not cause the essence of the corresponding technical solutions to deviate from the spirit and scope of the technical solutions of the embodiments of the present application.

What is claimed is:

1. A mouse set, comprising:
a mouse body, configured to input computer instructions;
a mouse base, provided at a target surface and provided at a bottom of the mouse body; and
a limiting portion, wherein the mouse body is detachably connected to the mouse base through the limiting portion, and the limiting portion is configured to limit movements of the mouse body and avoid the mouse body separating from the mouse base.

2. The mouse set according to claim 1, wherein the limiting portion comprises a first limiting assembly; the first limiting assembly comprises a first connecting member, and one of the mouse base and the mouse body is provided with the first connecting member; the mouse body is detachably connected to the mouse base through the first connecting member, and the first connecting member is configured to limit the movements of the mouse body and avoid the mouse body separating from the mouse base.

3. The mouse set according to claim 2, wherein:
the first connecting member is provided at the mouse base, and the mouse body is provided with a first limiting groove corresponding to the first connecting member; the first connecting member is magnetically connected to the mouse body, and an end of the first connecting member away from the mouse base is provided inside the first limiting groove; or
the first connecting member is provided at the mouse body, and the mouse base is provided with a first limiting groove corresponding to the first connecting member; the first connecting member is magnetically connected to the mouse base, and an end of the first connecting member away from the mouse body is provided inside the first limiting groove.

4. The mouse set according to claim 3, wherein:
the first connecting member is provided at the mouse base, and the mouse base is provided with a first receiving groove; the first connecting member is provided inside the first receiving groove and is rotatably matched with the mouse base; or
the first connecting member is provided at the mouse body, and the mouse body is provided with a first receiving groove; the first connecting member is provided inside the first receiving groove and is rotatably matched with the mouse base.

5. The mouse set according to claim 3, wherein:
the first connecting member is provided at the mouse base, and the mouse base is provided with a first receiving groove; a flange is provided at an opening of the first receiving groove; the first limiting assembly further comprises a limiting post, and the first connecting member is provided at one end of the limiting post; the limiting post is in sliding fit with the mouse base along a vertical direction, and a limiting ring is provided at an outer peripheral wall of the limiting post; in response to that the first connecting member is magnetically connected to the mouse body, the limiting post is in sliding fit with an inner wall of the first receiving groove, and the limiting ring is abutted against the flange; or
the first connecting member is provided at the mouse body, and the mouse body is provided with a first receiving groove; a flange is provided at an opening of the first receiving groove; the first limiting assembly further comprises a limiting post, and the first connecting member is provided at one end of the limiting post; the limiting post is in sliding fit with the mouse base along a vertical direction, and a limiting ring is provided at an outer peripheral wall of the limiting post; in response to that the first connecting member is magnetically connected to the mouse body, the limiting post is in sliding fit with an inner wall of the first receiving groove, and the limiting ring is abutted against the flange.

6. The mouse set according to claim 5, wherein a resetting member is provided between the limiting post and a bottom of the first receiving groove; one end of the resetting member is connected to the bottom of the first receiving groove, and the other end of the resetting member is connected to the limiting post; in response to that a magnetic connection between the first connecting member and the mouse body is released, the resetting member is configured to drive the limiting post to reset.

7. The mouse set according to claim 3, wherein the first limiting assembly further comprises a second connecting member; the second connecting member is provided in the first limiting groove and corresponds to the first connecting member, and the second connecting member is magnetically connected to the first connecting member;
the first connecting member is a magnet, and the second connecting member is an iron piece; or the first connecting member is an iron piece, and the second connecting member is a magnet; or the first connecting member is a magnet, and the second connecting member is a magnet.

8. The mouse set according to claim 2, wherein:
the limiting portion further comprises a second limiting assembly; the second limiting assembly is fixedly provided at the mouse base or the mouse body, to limit the mouse body and avoid the mouse body separating from the mouse base along a vertical direction;
the second limiting assembly comprises a first limiting member and a second limiting member; the first limiting member is provided at one end of the mouse base, and the second limiting member is provided at the other end of the mouse base;
the mouse body is provided with a third connecting member and a fourth connecting member; the third connecting member is disposed corresponding to the first limiting member, and the first limiting member is magnetically connected to the third connecting member; the fourth connecting member is disposed corresponding to the second limiting member, and the second limiting member is magnetically connected to the fourth connecting member; and
the first limiting member, the second limiting member, the third connecting member, and the fourth connecting member are magnets.

9. The mouse set according to claim 1, wherein the limiting portion comprises a first attachment member and a second attachment member;
the first attachment member is provided inside the mouse body or at the bottom of the mouse body, and a positioning groove is provided at the bottom of the mouse body;
the second attachment member is provided at the mouse base, and a positioning post is movably provided at the mouse base; an end of the positioning post is capable of extending out of a top of the mouse base or retracting inside the mouse base; and
in response to that the end of the positioning post extends out of the top of the mouse base, the positioning groove is connected to the end of the positioning post; the first attachment member is attracted to the second attachment member, and the mouse body is connected to the mouse base.

10. The mouse set according to claim 9, wherein:
the positioning post is rotatably disposed at the mouse base, and the positioning post is configured to rotate relative to the mouse base, to extend out of the top of the mouse base or retract inside the mouse base; or
the positioning post is pressed to pop out of the top of the mouse base or retract inside the mouse base.

11. The mouse set according to claim 10, wherein:
the positioning post is popped out from the top of the mouse base or retracted inside the mouse base by means of a push-push pressing structure;
a mounting hole is provided inside the mouse base; the push-push pressing structure is provided inside the mounting hole; the push-push pressing structure comprises an indexing cylinder, a rotating cylinder, and an elastic member;
an inner sidewall of the indexing cylinder is provided with a plurality of staggered deep grooves and shallow grooves; the rotating cylinder is provided inside the indexing cylinder, and an outer periphery of the rotating cylinder is provided with a plurality of engaging teeth; one end of the elastic element is connected to an inner of the rotating cylinder, and the other end of the elastic element is connected to an inner wall of the mouse base; the positioning post is connected to the rotating cylinder; and
in response to that the engaging teeth are connected to an inner of each of the deep grooves, the positioning post is configured to retract inside the mouse base; in response to that the engaging teeth are connected to an inner of each of the shallow grooves, the positioning post is popped out from the top of the mouse base.

12. The mouse set according to claim 11, wherein the indexing cylinder is integrated with the mouse base into one whole structure; the deep grooves and the shallow grooves are formed at an inner sidewall of the mounting hole.

13. The mouse set according to claim 11, wherein:
the mounting hole is a blind hole, and the elastic element is configured to abut against a bottom of the mounting hole; or
the mounting hole is a through hole; a blocking member is connected to a bottom of the mounting hole, and the elastic element is abutted against the blocking member.

14. The mouse set according to claim 9, wherein:
the mouse base is provided with a plurality of positioning posts, and the bottom of the mouse body is provided with a plurality of positioning grooves;
the plurality of positioning posts are symmetrically distributed about a straight line, and the second attachment member is symmetrical about the straight line; and
the first attachment member is disposed corresponding to the second attachment member.

15. The mouse set according to claim 9, wherein:
the first attachment member comprises a magnetic member, and the second attachment member comprises a magnetic member and a non-magnetic component to be magnetically attracted; or
the first attachment member comprises a magnetic member and a non-magnetic component to be magnetically attracted, and the second attachment member comprises a magnetic member.

16. The mouse set according to claim 9, wherein:
a bottom of the mouse base is provided with an adhesive layer, or
a bottom of the mouse base is provided with a magnetic attachment member, or
a bottom of the mouse base is detachably connected to the target surface through a quick-release structure.

17. The mouse set according to claim 1, wherein:
the limiting portion comprises a third limiting member; one of the mouse base and the mouse body is provided with the third limiting member and a second receiving groove, and the other of the mouse base and the mouse body is provided with a second limiting groove; the third limiting member is rotatably disposed at the mouse base or the mouse body; and
the third limiting member comprises a first end and a second end, and a movement direction of the first end is opposite to a movement direction of the second end; in response to that the mouse body is provided at the mouse base, the third limiting member is configured to rotate, and the first end is located in the second receiving groove; and the second end is located in the second limiting groove, to avoid the mouse body separating from the mouse base.

18. The mouse set according to claim 17, wherein:
the third limiting member is rotatably disposed at the mouse base; the second receiving groove is provided in the mouse base, and the third limiting member is rotatably matched with the mouse base through a connecting shaft;
the mouse body is provided with an abutment member; the abutment member is disposed corresponding to the first end, and the abutment member is configured to abut against the first end, to make the first end move towards the second receiving groove;
the first end is provided with a first magnet, and the abutment member is configured as a magnet repelling the first magnet; the second end is provided with a second magnet, and an inner wall of the second receiving groove is provided with a first magnetic element magnetically attracted to the second magnet; a magnetic force between the first magnetic element and the second magnet is less than a magnetic force between the abutment member and the first magnet; and
the connecting shaft is provided at a center point of the third limiting member, and a distance between the first magnet and the connecting shaft is equal to a distance between the second magnet and the connecting shaft.

19. The mouse set according to claim 17, wherein:
the limiting portion further comprises a first connecting assembly and a second connecting assembly; the first connecting assembly is provided at a front end of the mouse set, and the second connecting assembly is provided at a rear end of the mouse set; the first connecting assembly and the second connecting assembly are configured to limit the mouse body and avoid the mouse body separating from the mouse base along a vertical direction; and
the first connecting assembly comprises a first magnetic attraction member and a second magnetic attraction member; the first magnetic attraction member is provided at one of the mouse base and the mouse body; the second magnetic attraction member is provided at the other of the mouse base or the mouse body; the first magnetic attraction member is magnetically connected to the second magnetic attraction member.

20. The mouse set according to claim 19, wherein:
the second connecting assembly comprises a third magnetic attachment member and a fourth magnetic attachment member; the third magnetic attachment member is provided at one of the mouse base and the mouse body, and the fourth magnetic attachment member is provided at the other of the mouse base and the mouse body; the third magnetic attachment member is magnetically connected to the fourth magnetic attachment member; and
the first magnetic attachment member, the second magnetic attachment member, the third magnetic attachment member, and the fourth magnetic attachment member are magnets.
